(19) United States
(12) Patent Application Publication
(10) Pub. No.: US 2012/0194622 A1
(43) Pub. Date: Aug. 2, 2012

(54) ULTRA VIOLET LIGHT EMITTING DIODE CURING OF UV REACTIVE INK

(75) Inventors: Muhammad Iraqi, Tira (IL); Yosi Cherbis, Haifa (IL); Eva Igner, Haifa (IL)

(73) Assignee: CAMTEK LTD., Migdal Haemek (IL)

(21) Appl. No.: 13/346,810

(22) Filed: Jan. 10, 2012

Related U.S. Application Data
(60) Provisional application No. 61/437,717, filed on Jan. 31, 2011.

(51) Int. Cl. B41J 2/01

(52) U.S. Cl. 347/102

(57) ABSTRACT

A method for printing a pattern on a electrical circuit, the method includes jetting on the electrical circuit an ultraviolet curable ink to form a pattern; and at least partially curing the ultraviolet curable ink by exposing the pattern to ultraviolet radiation generated from at least one ultraviolet light emitting diode (LED).

### RELATED APPLICATIONS

This application claims priority from U.S. provisional patent Ser. No. 61/437717 filing date Jan. 31, 2011.

### BACKGROUND

UV reactive ink types, and solder mask as an example, are usually cured using a broadband ultra violet (UV) light radiation emitted from broadband mercury/mercury doped with metal halides such as lead, iron, etc. bulbs.

Proper curing of the inks is an absolute necessity for the success of the coating process.

UV light radiation is a well-known source for curing the UV based materials during the ink-jet printing phase. The material includes agents that are designed to react with the wavelengths provided by the curing light source. A most common source for UV uses arc lamp technology. Arc lamps provide a wide range of wavelengths. Some of these wavelengths are effective in curing the material, shorter wavelengths being more effective at the surface, longer wavelengths being capable of penetrating deeper into the material and curing the deeper regions. Yet much of the radiated wavelengths are not used for curing and instead generate heat inside the material and may cause unwanted deformations or even ignition.

To operate, arc lamps require high voltages in order to excite superheated plasma consisting of various gases. Most of the generated light does not contribute to the curing process and is wasted as heat inside the lamp. The heat has to be evacuated using air or liquid. UV arc lamps have a limited lifetime of 500 to 1000 hours, deteriorate gradually during their lifetime and require elaborate electronics to manage the operating conditions. Lamps are not readily turned on and off and so, shutters are required to block the light where necessary. Certain UV wavelengths generate ozone which is a harmful gas that has to be evacuated if the wavelengths that generate the ozone are not properly filtered. In addition Mercury lamps contain also mercury vapors that are highly toxic and need to be handled carefully, breaking of the lamp can release hazardous mercury vapors.

There is a growing need to provide efficient curing methods. LEDs provide an efficient way of light generation. Heat generation is minimal, operating temperatures are easy to manage. LEDs can be readily turned on and off, a characteristic much needed in ink-jet printers. LEDs generate a narrow spectrum of light, and those that operate in the UV spectrum have not yet been effective in the deep UV wavelengths.

### SUMMARY

A method for printing a pattern on an electrical circuit may be provided, the method includes: jetting on the electrical circuit an ultraviolet curable ink to form a pattern; and at least partially curing the ultraviolet curable ink by exposing the pattern to ultraviolet radiation generated from at least one ultraviolet light emitting diode (LED).

The method may include exposing the pattern to monochromatic ultraviolet radiation.

The method may include illuminating the pattern with ultraviolet radiation that may include multiple wavelengths that differ from each other.

The multiple wavelengths may be selected such as to provide a substantially uniform curing of the pattern Both surface cure with LEDs emitting UV radiation in the wavelength range 360-370 nm and deep cure with LED or LEDs emitting UV radiation in the wavelength range 380-400 nm.

The different LEDs narrow width wavelength ranges are selected to mostly match the absorption wavelength ranges of the different photo-initiators introduced into the UV ink formulation

The multiple wavelengths may be selected such as to provide a same curing of an upper surface of the pattern and of a lower surface of the pattern.

The method may include illuminating the pattern by an array of ultraviolet LEDs.

The method may include illuminating the pattern by an array of ultraviolet LEDs, wherein at least two ultraviolet LEDs of the array differ from each other by a wavelength of emitted ultraviolet radiation.

The method may include jetting an ultraviolet curable ink to form a legend pattern.

The method may include jetting an ultraviolet curable ink to form a solder mask pattern.

The method may include jetting an ultraviolet curable ink to form an etch resist pattern.

The ultraviolet ink may be selected based upon an expected penetration of the ultraviolet radiation through the ultraviolet ink.

The ultraviolet curable ink may include an ultraviolet responsive photo-initiator mixture, ultraviolet curable monomers, a thermosetting resin and at least one out of pigments and fillers.

The ultraviolet responsive photo-initiator mixture may include zero or more reactive monomers, zero or more co-initiator and at least one active photo initiator.

A system may be provided and may include a printing module arranged to jet on an electrical circuit an ultraviolet curable ink to form a pattern; and a curing module arranged to at least partially cure the ultraviolet curable ink by irradiating the pattern with ultraviolet radiation generated from at least one ultraviolet light emitting diode (LED) of the curing module.

The curing module may be arranged to illuminate the pattern with monochromatic ultraviolet radiation.

The curing module may be arranged to illuminate the pattern with ultraviolet radiation that may include multiple wavelengths that differ from each other.

The multiple wavelengths may be selected such as to provide a substantially uniform curing of the pattern.

The multiple wavelengths may be selected such as to provide a same curing of an upper surface of the pattern and of a lower surface of the pattern.

The curing module may be arranged to illuminate the pattern by an array of ultraviolet LEDs.

The curing module may be arranged to illuminate the pattern by an array of ultraviolet LEDs, wherein at least two ultraviolet LEDs of the array differ from each other by a wavelength of emitted ultraviolet radiation.

The printing module may be arranged to jet an ultraviolet curable ink to form a legend pattern.

The printing module may be arranged to jet an ultraviolet curable ink to form a solder mask pattern.

The printing module may be arranged to jet an ultraviolet curable ink to form an etch resist pattern.

The printing module may be arranged to jet ultraviolet ink that may be selected based upon an expected penetration of the ultraviolet radiation through the ultraviolet ink.

The printing module may be arranged to jet ultraviolet ink that may include an ultraviolet responsive photo-initiator mixture, ultraviolet curable monomers, a thermosetting resin and at least one out of pigments and fillers.

The ultraviolet responsive photo-initiators mixture may include zero or more reactive monomers, zero or more co-initiator and at least one active photo initiator.

An ultraviolet curable ink may be provided and may include an ultraviolet responsive photo-initiators mixture, ultraviolet curable monomers, a thermosetting resin and at least one out of pigments and fillers.

### BRIEF DESCRIPTION OF THE DRAWINGS

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

FIG. 1 illustrates a LED array according to an embodiment of the invention;

FIG. 2 illustrates a system according to an embodiment of the invention; and

FIG. 3 illustrates a spectrum of a UV LED according to an embodiment of the invention; and

FIG. 4 is a flow chart of a method for printing, according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. There may be provided an ink formulation that is designed to support LED curing, and can be chemically adjusted for being cured by the single wavelength that is generated by the LED provides.

The terms illuminating, exposing and irradiating are used in an interchangeable manner in this specification.

Additionally or alternatively, in order to ensure even curing of both the surface and the deeper regions of the coating, a number of wavelengths can be generated by the LED illumination module. This may lead to the use of several LED devices each with a wavelength that will be effective at a respective depth.

It is the purpose of this invention to provide a photo initiator (PI) components or mixtures of materials that should compensate for the missing short wavelength UV radiation

For example solder mask inks are applied on printed circuit boards using various methods. Conventionally, solder mask is applied on the entire surface and dried. Photo imaging is then used to expose solder mask and remove exposed areas (or remove unexposed areas, depending on the type of solder mask material). The remaining material is then cured.

This system and method can be used for example in the field of ink jet printing techniques for selective application of solder mask. This involves liquid materials that have physical and chemical characteristics that enable jetting. Once on the substrate, the liquids have to be cured in order to fix them in their designated location and stop them from flowing. The curing action may be final, in the sense that no further curing is necessary, or it may be an initial phase towards further and final curing, for example, thermally or using other light sources.

Full and proper curing may be required for the solder mask to provide the necessary cured film properties such as mechanical strength, adhesion and chemical resistance during the lifetime of the printed circuit board throughout finishing processes, (manufacturing), assembly and operation within an instrument. Coatings that are colored using various methods (for example using pigments) provide an additional challenge in that the entire body of the coating starting at the surface and until the bottom has to be cured evenly. If curing starts at the surface before the deeper regions, then a thin film may form at the surface. This film may deform as the inner layers change from liquid to solid.

In order to use LEDs as curing devices for solder mask ink, special agents that react to the narrow bandwidth of the light source have to be present in the ink. Furthermore, these agents react to the UV light, and should allow the final cured product to operate and fulfill its purpose of providing long term protection and withstand very aggressive finishing processes during the following manufacturing steps.

One side effect of the narrow wavelength is that it may be effective either at the surface of the cured coating or deep inside. Different wavelengths penetrate differently based on the pigments type of the coated material.

There is provided a system that may include the necessary elements for using UV LEDs within a system, including UV LEDs and chemical compositions specifically formulated for use with UV LEDs.

Most UV curable inks, and solder mask inkjet inks as an example, were cured using medium pressure broadband mercury/lead based UV bulbs. Due to the many benefits of LEDs over the current UV bulbs, there is a growing need to adjust the solder mask inks to support these LEDs and their spectrum specification.

Both the solder mask developed and the curing method, should comply to the PCB and/or Substrate and/or Microelectronics industries' standards in terms of chemical properties, mechanical properties, electrical properties and chemical resistance.

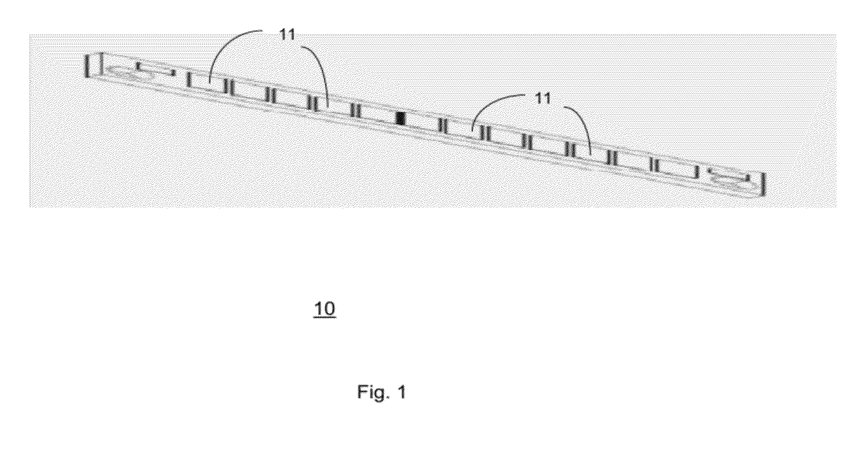

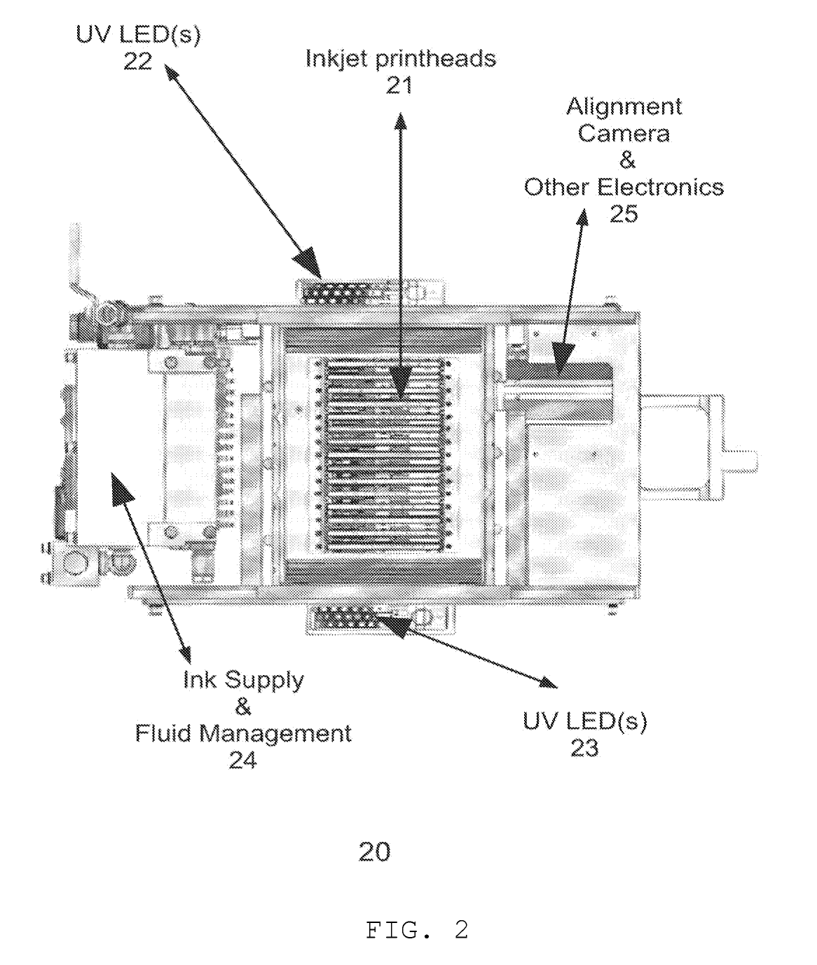

A system equipped with UV LEDs arrays is provided. The array can be one-dimensional array, two-dimensional array, an ordered array, and the like. FIG. 1 illustrates a LEDs array 10 that includes several LEDs (illustrated as boxes) 11 according to an embodiment of the invention. Each LED may radiate UV light of the same wavelength or, alternatively, may radiate UV light of different wavelengths that will effectively cure different depth portions of the coating material. The LED illumination array can be located in both the front ,the back or in between of a print head cartridge, as illustrated in FIG. 2—see UV LEDs 22 and 23.

FIG. 2 depicts a possible setup of the print heads within a system 20. In this setup printing can be performed by moving the print target relative to the print heads (inkjet printheads 21) in both directions, the curing action performed by the respective LED array situated after the print heads. The print head may include support subsystems such as ink supply, cleaning, cameras for alignment, electronic circuits, fluid management, and other equipment.

The system 20 also includes alignment camera and other electronics 25, ink supply and fluid management 24.

According to an embodiment of the invention the solder mask ink include an ultraviolet responsive photo initiator (PI) or a mixture of ultraviolet responsive photo-initiators that are introduced in the formulation to allow the UV curing process once the printed area is exposed to LED UV light.

The absorption spectra of the different PI should correlate with the irradiance spectra of the LEDs used to cure UV responsive mixtures of ink.

The ultraviolet responsive PI mixture should react to the monochromatic (or narrowband) radiation of the LED UV.

LEDs emitting different wavelengths may require different PIs. Typically, LEDs emit UV light in the range of 365-395 nm In addition, if UV LEDs of several wavelengths are used to effectively cure various depths of the coating material, there may be several ultraviolet responsive PIs or mixtures of ultraviolet responsive PI and other materials that react to the various wavelengths present in the overall radiation that need to be absorbed accordingly.

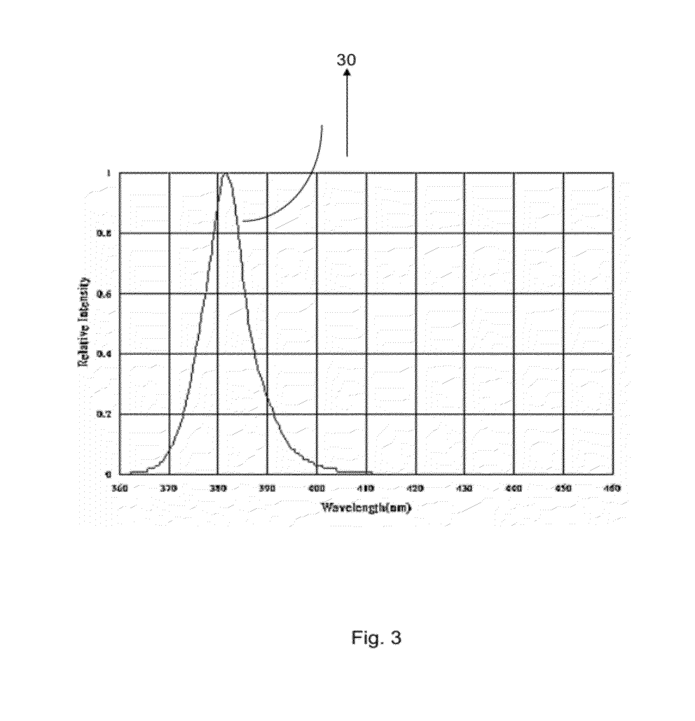

FIG. 3 illustrates an example of a spectrum of a UV LED. Curve 30 illustrates the spectrum.

Typical Optical Characteristics at 700 mA. Radiation Power Po=150 mW. Peak Wavelength λp=368 nm. Full Width at Half Maximum: Δλ=10 nm. Viewing Angle 2θ½=110 Degree.

The inventors evaluated various mixtures adjusted for legend (marking) and solder mask inkjet inks that can be cured by UV light emitted from LED UV source.

An example of the solder mask ink comprises of a following mixture:

1. Ultraviolet responsive PI mixture—for example a mixture that includes (a) zero or more reactive monomers (e.g. amine acrylates, Ebecryl P 116), (b) zero or more co-initiator (e.g. synergist, Additol ITX), and (c) at least one active photo initiator (e.g. Irgacure 369, Irgacure 651,benzophenone, Irgacue 379, Irgacue 184 and the like).

2. Monomers such as radically UV curable mono-functional acrylates (e.g. Isoburnyl acrylate), radically UV curable Di-functional acrylates (e.g. Di-propylene Glycol Di-acrylate), acrylate oligomers ( ).

3. Thermosetting resins, such as phenolic resin, amine resin.

4. Pigments and/or fillers (e.g. TiO2, BaSO4).

In this example, a 24 micron thick solder mask coating requires about 300 mJ/cm² energy dose to become tack-free.

With the required curing energy, and given the power of the LED, the exposure time can be calculated. Alternatively, based on the required curing energy and the expected exposure time, the required LED power can be calculated.

The ultraviolet responsive PI mixture is mixed with a solder mask inkjet ink and can become reactive towards a range of 280-400 nm UV light emitted from a LED UV source.

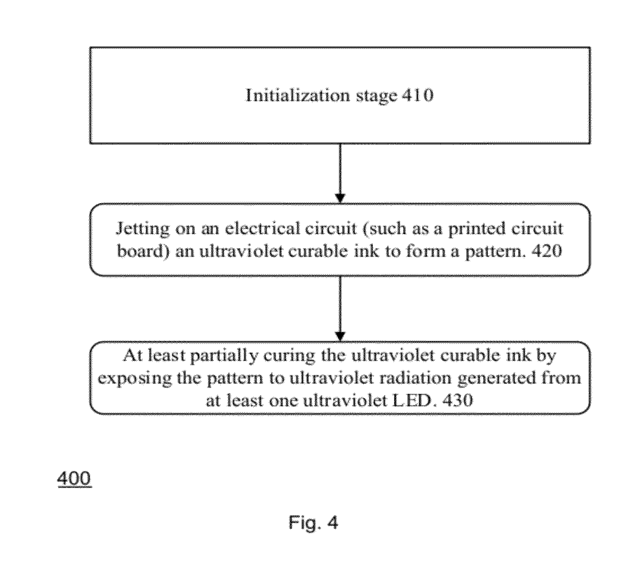

FIG. 4 illustrates method 400 according to an embodiment of the invention. Method 400 may start by initialization stage 410.

Stage 410 may include selecting an ultraviolet curable ink to be used, determining curing process parameters such as radiation duration (pulsed, continuous), wavelength of radiation (for example—which ultraviolet LEDs should be activated) and the like.

Stage 410 may be followed by stage 420 of jetting on an electrical circuit (such as a printed circuit board) an ultraviolet curable ink to form a pattern.

The ultraviolet ink may be selected based upon an expected penetration of the ultraviolet radiation through the ultraviolet ink.

The ultraviolet curable ink may include an ultraviolet responsive photo-initiators mixture, ultraviolet curable monomers, a thermosetting resin and at least one out of pigments and fillers.

The ultraviolet responsive photo-initiators mixture may include zero or more reactive monomers, zero or more co-initiator and at least one active photo initiator.

Stage 420 may include exposing the pattern by an array of ultraviolet LEDs.

Stage 420 may include exposing the pattern by an array of ultraviolet LEDs, wherein at least two ultraviolet LEDs of the array differ from each other by a wavelength of emitted ultraviolet radiation.

Stage 420 may include jetting an ultraviolet curable ink to form a legend pattern.

Stage 420 may include jetting an ultraviolet curable ink to form a solder mask pattern.

Stage 420 may be followed by stage 430 of at least partially curing the ultraviolet curable ink by irradiating the pattern with ultraviolet radiation generated from at least one ultraviolet LED.

Stages 420 may be repeated multiple times, for generating multiple patterns and additionally or alternatively for generating multiple layers of multiple patterns.

There can be a tradeoff between the depth (thickness) of a layer of a pattern and the number of iterations Thinner layers will contribute to the uniformity of the printing but can require more printing and curing iterations.

Stage 430 may include irradiating the pattern with monochromatic ultraviolet radiation.

Stage 430 may include irradiating the pattern with ultraviolet radiation that may include multiple wavelengths that differ from each other. The multiple wavelengths may be selected such as to provide a substantially uniform curing of the pattern. The multiple wavelengths may be selected such as to provide same curing of an upper surface of the pattern and of a lower layer of the pattern.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for printing a pattern on a electrical circuit, the method comprises:
jetting on the electrical circuit an ultraviolet curable ink to form a pattern; and
at least partially curing the ultraviolet curable ink by exposing the pattern to ultraviolet radiation generated from at least one ultraviolet light emitting diode (LED).

2. The method according to claim 1, comprising irradiating the pattern with monochromatic ultraviolet radiation.

3. The method according to claim 1, comprising irradiating the pattern with ultraviolet radiation that comprises multiple wavelengths that differ from each other.

4. The method according to claim 3, wherein the multiple wavelengths are selected such as to provide a substantially uniform curing of the pattern.

5. The method according to claim 3, wherein the multiple wavelengths are selected such as to provide a same curing of an upper surface of the pattern and of a lower layer of the pattern.

6. The method according to claim 1, comprising irradiating the pattern by an array of ultraviolet LEDs.

7. The method according to claim 1, comprising irradiating the pattern by an array of ultraviolet LEDs, wherein at least two ultraviolet LEDs of the array differ from each other by a wavelength of emitted ultraviolet radiation.

8. The method according to claim 1, comprising jetting an ultraviolet curable ink to form a legend pattern.

9. The method according to claim 1, comprising jetting an ultraviolet curable ink to form a solder mask pattern.

10. The method according to claim 1, comprising jetting an ultraviolet curable ink to form an etch resist pattern.

11. The method according to claim 1, wherein the ultraviolet ink is selected based upon an expected penetration of the ultraviolet radiation through the ultraviolet ink.

12. The method according to claim 1, wherein the ultraviolet curable ink comprises an ultraviolet responsive photo-initiators mixture, ultraviolet curable monomers, a thermosetting resin and at least one out of pigments and fillers.

13. The method according to claim 12, wherein the ultraviolet responsive photo-initiators mixture comprises zero or more reactive monomers, zero or more co-initiator and at least one active photo-initiator.

14. A system, comprising:
a printing module arranged to jet on an electrical circuit an ultraviolet curable ink to form a pattern; and
a curing module arranged to at least partially cure the ultraviolet curable ink by irradiating the pattern with ultraviolet radiation generated from at least one ultraviolet light emitting diode (LED) of the curing module.

15. The system according to claim 14, wherein the curing module is arranged to irradiate the pattern with monochromatic ultraviolet radiation.

16. The system according to claim 14, wherein the curing module is arranged to irradiate the pattern with ultraviolet radiation that comprises multiple wavelengths that differ from each other.

17. The system according to claim 16, wherein the multiple wavelengths are selected such as to provide a substantially uniform curing of the pattern.

18. The system according to claim 16, wherein the multiple wavelengths are selected such as to provide same curing of an upper surface of the pattern and of a lower layer of the pattern.

19. The system according to claim 14, wherein the curing module is arranged to irradiate the pattern by an array of ultraviolet LEDs.

20. The system according to claim 14, wherein the curing module is arranged to irradiate the pattern by an array of ultraviolet LEDs, wherein at least two ultraviolet LEDs of the array differ from each other by a wavelength of emitted ultraviolet radiation.

21. The system according to claim 14, wherein the printing module is arranged to jet an ultraviolet curable ink to form a legend pattern.

22. The system according to claim 14, wherein the printing module is arranged to jet an ultraviolet curable ink to form a solder mask pattern.

23. The system according to claim 14, wherein the printing module is arranged to jet an ultraviolet curable ink to form an etch resist pattern.

24. The system according to claim 14, wherein the printing module is arranged to jet ultraviolet ink that is selected based upon an expected penetration of the ultraviolet radiation through the ultraviolet ink.

25. The system according to claim 14, wherein printing module is arranged to jet ultraviolet ink that comprises an ultraviolet responsive photo-initiators mixture, ultraviolet curable monomers, a thermosetting resin and at least one out of pigments and fillers.

26. The system according to claim 25, wherein the ultraviolet responsive photo-initiators mixture comprises zero or more reactive monomers, zero or more co-initiator and at least one active photo initiator.

27. An ultraviolet curable ink, comprising: an ultraviolet responsive photo-initiators mixture, ultraviolet curable monomers, a thermosetting resin and at least one out of pigments and fillers.
